(19) United States
(12) Patent Application Publication
(10) Pub. No.: US 2008/0221813 A1
(43) Pub. Date: Sep. 11, 2008

(54) Jitter-Based Calibration Procedure With Improved Resolution For Optical Disc Drives

(75) Inventor: Alexander Ulrich Douglas, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/914,261

(22) PCT Filed: May 10, 2006
(86) PCT No.: PCT/IB2006/051467

§ 371 Date: Nov. 13, 2007

(30) Foreign Application Priority Data
May 18, 2005 (EP) 05104177.0

(51) Int. Cl. G06F 19/00

(52) U.S. Cl. 702/69

(57) ABSTRACT

An optical disc drive apparatus (1), suitable for storing information on or reading information from an optical disc (2), typically a DVD or a CD or a BD, is designed for performing a method for calibrating a jitter factor (X) on the basis of optimising jitter, the method comprising the steps of: receiving a read signal (S_{R}) from the optical disc (2); detecting a zero-crossing in the read signal; measuring (steps 111, 112) a timing error (tπ(i)) of the zero-crossing; measuring (step 113) a steepness (β(i)) of the zero-crossing; calculating (step 114) a weighing factor (α(i)) on the basis of the measured steepness (β(i)), this weighing factor (α(i)) being smaller for smaller values of the steepness (P(O); calculating (step 115) a weighed single jitter value (t_{w}(i) by multiplying said timing error (tπ(i)) and said weighing factor (α(i)); and using this weighed single jitter value for calibration.

The present invention relates in general to a disc drive apparatus for writing/reading information into/from an optical storage disc; hereinafter, such disc drive apparatus will also be indicated as “optical disc drive”.

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writable type, where information may be stored by a user. For writing information in the storage space of the optical storage disc, or for reading information from the disc, an optical disc drive comprises, on the one hand, rotating means for receiving and rotating an optical disc, and on the other hand optical scanning means for optically scanning the storage track of the rotating disc. Since the technology of optical discs in general, the way in which information can be stored in an optical disc, and the way in which optical data can be read from an optical disc, is commonly known, it is not necessary here to describe this technology in great detail.

For optically scanning the rotating disc, an optical disc drive comprises a light beam generator device (typically a laser diode), an objective lens for focussing the light beam in a focal spot on the disc, and an optical detector for receiving the reflected light reflected from the disc and for generating an electrical detector output signal. The reflected light is modulated according to the data pattern of the track under scan, which modulation translates into modulation of the electrical detector output signal.

Basically, in the case of a ROM disc, the data pattern of the track under scan consists of a series of “pits”, whereas in the case of a rewritable disc, the data pattern consists of a series of phase changes in the disc material. Thus, the laser beam either reflects from a pit or from a non-pit, also indicated as “land”, hence the electrical detector output signal basically can take two values, representing logical data bits of ones and zeros. Between these two values, a reference level is defined. At a transition from one data bit to a next data bit of opposite sign, the electrical detector output signal or data signal makes a transition from the one value to the other value and crosses said reference level. In the following, it will be assumed that said reference level is the zero level, and that said two values of the data signal have equal magnitude and opposite sign. Crossing the reference level will be indicated as a “zero-crossing”.

The bit frequency of the data signal, or channel bit rate, must satisfy predetermined specifications. For example, the channel bit rate for DVD is equal to 26.16 MHz, in which case the channel bit period is equal to 38.2 ns. Thus, the zero crossings of the data signal are expected to occur at mutual distances of N times the channel bit period, N being an integer. In practice, the actual timing of the zero crossings may deviate from the expected timing; this deviation or timing error is called “jitter”.

Jitter can be expressed in nanoseconds, but jitter is often expressed as a percentage of the channel bit period. For instance, in the above example, a timing error of 3 ns corresponds to a jitter of about 8%.

In general, a disc drive has several apparatus parameters which need to be calibrated to an optimum value for being able to correctly (with as few errors as possible) read and/or write a disc, such as for instance beam focus and disc tilt (radial; tangential). Errors in the settings of these parameters (i.e. deviation from the optimum values) causes a degradation of the quality of the readout channel. Eventually, it may become difficult or even impossible to correctly process the data signal. Jitter is considered to be a good measure of the quality of the readout channel, lower values of the jitter corresponding to better setting of said parameters thus corresponding to better quality of the readout channel.

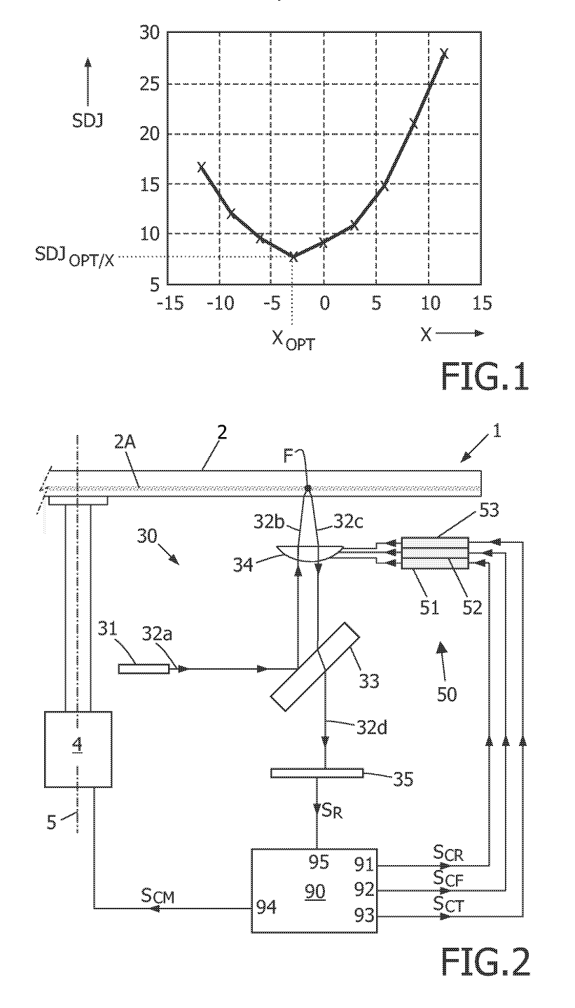

In general, the jitter depends on several drive parameters. Drive apparatus parameters which influence the jitter will hereinafter be indicated as “jitter factor”. A jitter factor typically has an optimum value at which the jitter is at a relative minimum. Or, better worded, if the jitter factor deviates from its optimum value, the jitter increases. The relationship between a jitter factor and the resulting jitter can be graphically illustrated by a so-called “bathtub” curve or jitter curve. FIG. 1 shows a typical example of such curve; the horizontal axis represents disc tilt in mrad, the vertical axis represents jitter in percentage of channel bit period. In this example, the jitter factor (disc tilt) has an optimum value of −3 mrad, the corresponding optimum jitter value being 8%.

In the following, the optimum value of a jitter factor will be indicated as “optimum factor value”.

It is noted that, in a real apparatus, multiple jitter factors may contribute to the jitter value, in which case changing the value of one jitter factor may change the optimum factor value of a second jitter factor.

In a calibration procedure, a disc drive sets a jitter factor to its optimum factor value. This calibration procedure may be performed once, when a disc is introduced into the disc drive, but it is also possible that the calibration procedure is performed on a regular basis, for instance at regular time intervals, or when the scanning process enters a different region of the disc, etc. Typically, the calibration procedure involves varying the jitter factor and measuring the jitter for a number of different jitter factor values, thus obtaining a few measuring points of the jitter curve (for instance, the crosses in FIG. 1), and calculating an optimum factor value from the obtained measurements.

The calculation method for calculating the optimum factor value may vary. It is possible to simply take the jitter factor value corresponding to the lowest measured jitter. It is also possible to approximate a jitter curve by a parabolic curve (best fit; least squares method) and to calculate the bottom of that curve. Whatever the calculation method used, it should be clear that the calibration procedure can be performed faster, with less measurements, and that the outcome of the calibration procedure is more reliable as the jitter curve is deeper.

As an ongoing development, optical discs are developed with increasing capacity. Larger capacity involves smaller dimensions of the data pits, hence smaller channel bit periods. At such high bit rates, an optimum setting of the said parameters is even more important. However, inventors have found that jitter curves tend to flatten, i.e. become less deep, as the disc storage capacity increases. A flatter jitter curve has reduced resolution for calibration purposes. Thus, while on the one hand the correct calibration of a parameter becomes more important, the traditional jitter curve becomes less suitable for this purpose. This problem, which was found to be quite important in the case of a 27 GB Blu-Ray disc currently under development, may well be a hindrance to develop optical discs of higher capacity.

It is a general objective of the present invention to overcome or at least reduce the above problem.

Specifically, the present invention aims to improve the resolution of a jitter-based calibration procedure.

When performing jitter measurements (see for instance FIG. 1), one does not simply consider the timing error of one zero crossing. Instead, many zero crossings are considered (typically in the order of 1000 or more), and the corresponding timing errors as measured are processed to calculate a statistical jitter value. According to the processing of the state of the art, all measurements have the same weight. In contrast, according to the present invention, the measurements are weighed according to the steepness of the corresponding zero crossing. More specifically, the weighing factor is proportional to the steepness of the corresponding zero crossing. Inventors have found that, if the weighted timing errors are processed instead of the timing errors as measured, the characteristic bathtub curve may become deeper, thus improving the resolution of the calibration procedure.

In alternative solutions for the above-mentioned problems, complicated algorithms in the bit detector might be employed. By way of example, a Viterbi detector is mentioned. An important advantage of the present invention is the simplicity of the proposed solution.

It is noted that calibration of parameters in a disc drive may alternatively be performed on the basis of different variables, for instance bit error rate or symbol error rate. However, measurements based on jitter are more easily obtained and more quickly available.

It is noted that EP-1.118.866 discloses a method for calculating the timing of a zero-crossing. In this calculation, samples of the data signal are obtained at opposite sides of the reference level, and a weighing factor is used to calculate an estimate of the time of the zero crossing. However, when calculating a jitter value on the basis of a plurality of zero-crossings, all zero-crossings are treated with the same weight.

These and other aspects, features and advantages of the present invention will be further explained by the following description with reference to the drawings, in which same reference numerals indicate same or similar parts, and in which:

FIG. 1 is a graph schematically illustrating a jitter curve;

FIG. 2 is a diagram schematically illustrating relevant components of an optical disc drive apparatus;

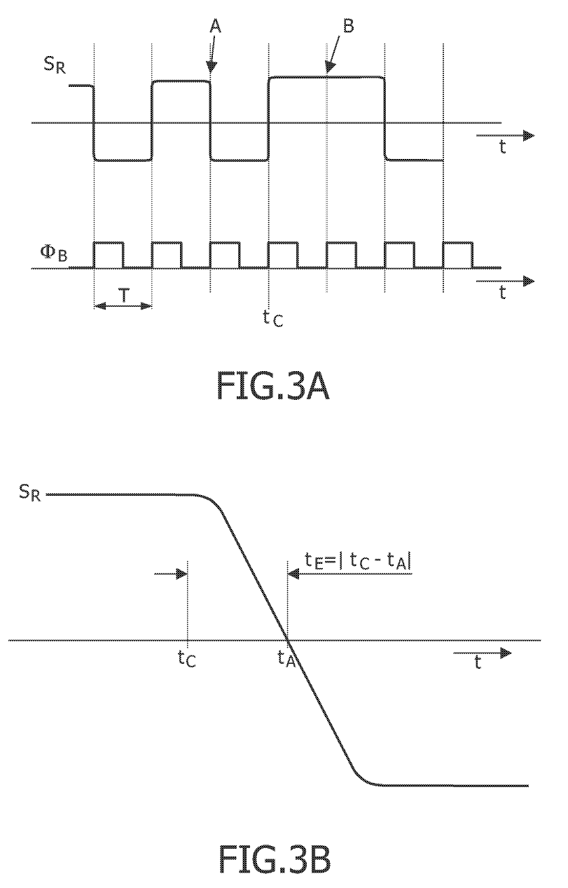

FIGS. 3A and 3B are graphs illustrating the timing of zero-crossings in a data signal;

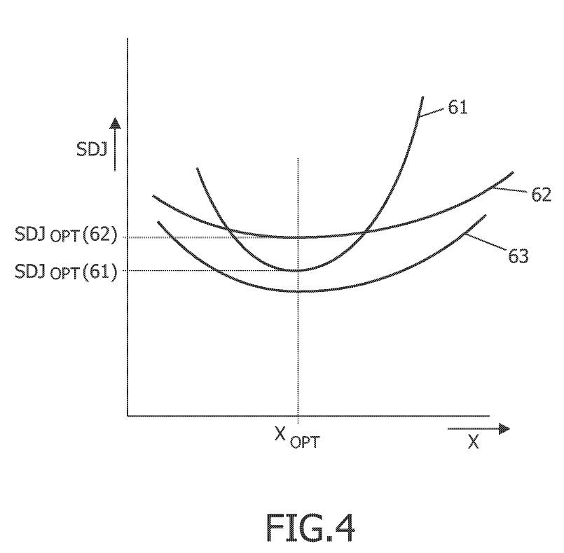

FIG. 4 is a graph comparable to FIG. 1, schematically illustrating an effect of increased disc drive storage capacity on a jitter curve;

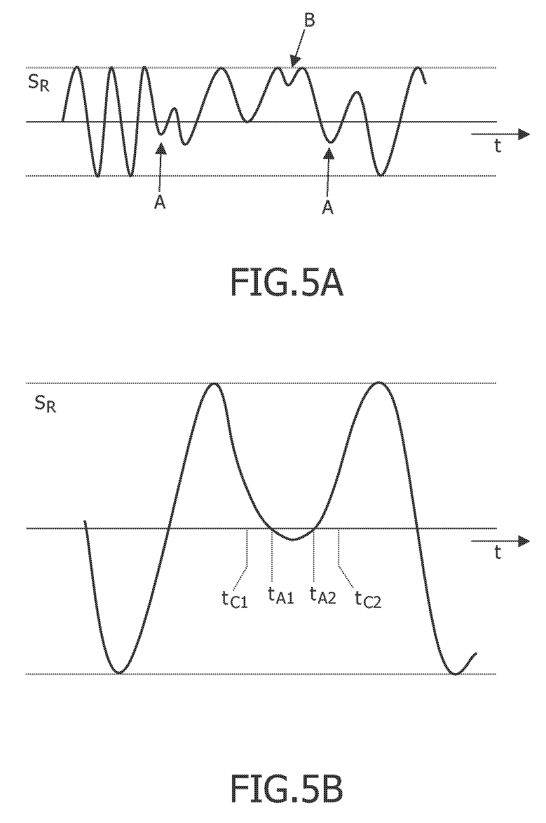

FIGS. 5A and 5B are graphs illustrating incomplete zero-crossings of a data signal;

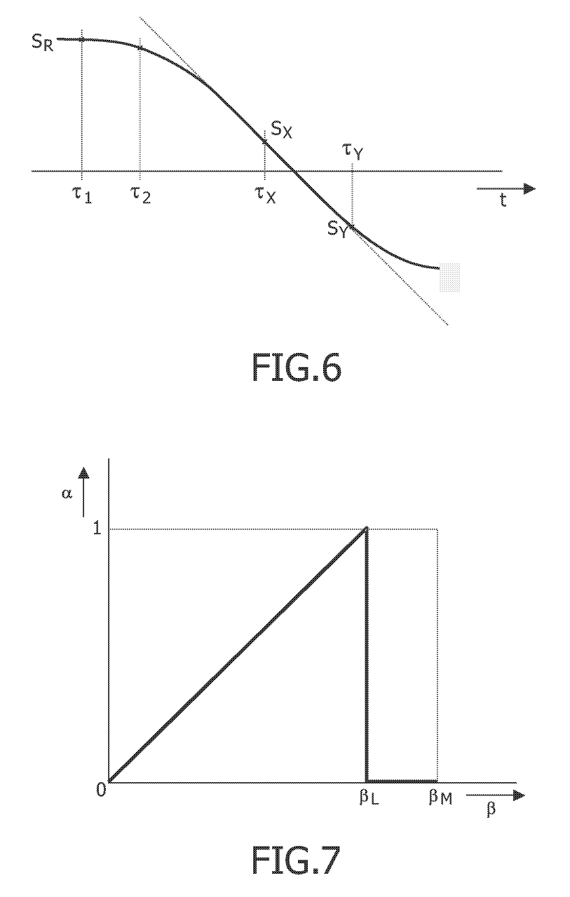

FIG. 6 is a graph for illustrating how timing and steepness of a zero-crossing can be approximated;

FIG. 7 is a graph illustrating a preferred relationship between weighing factor and steepness;

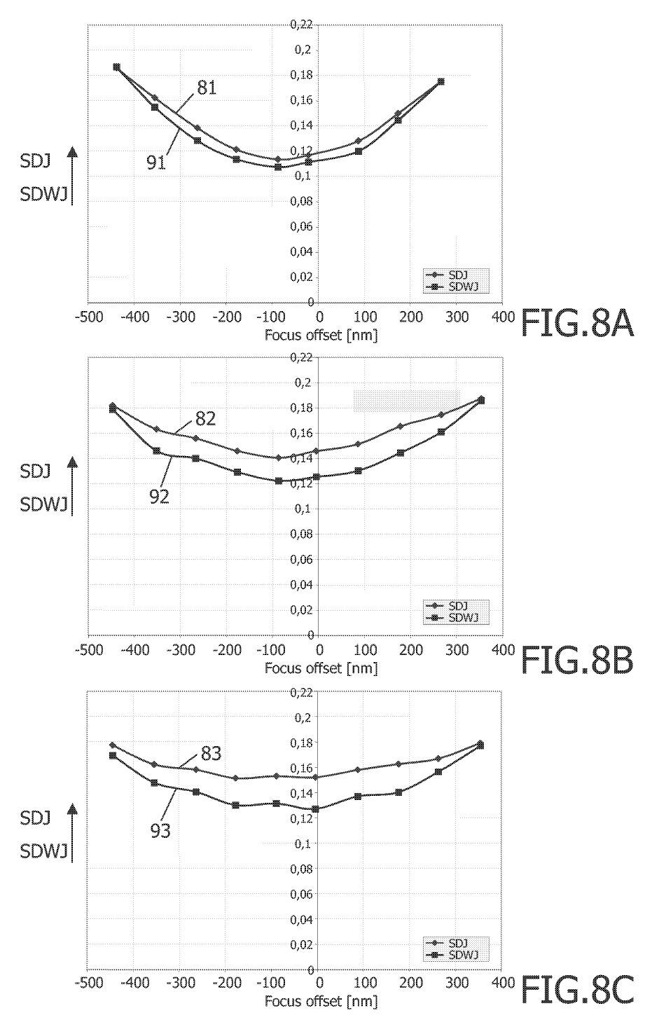

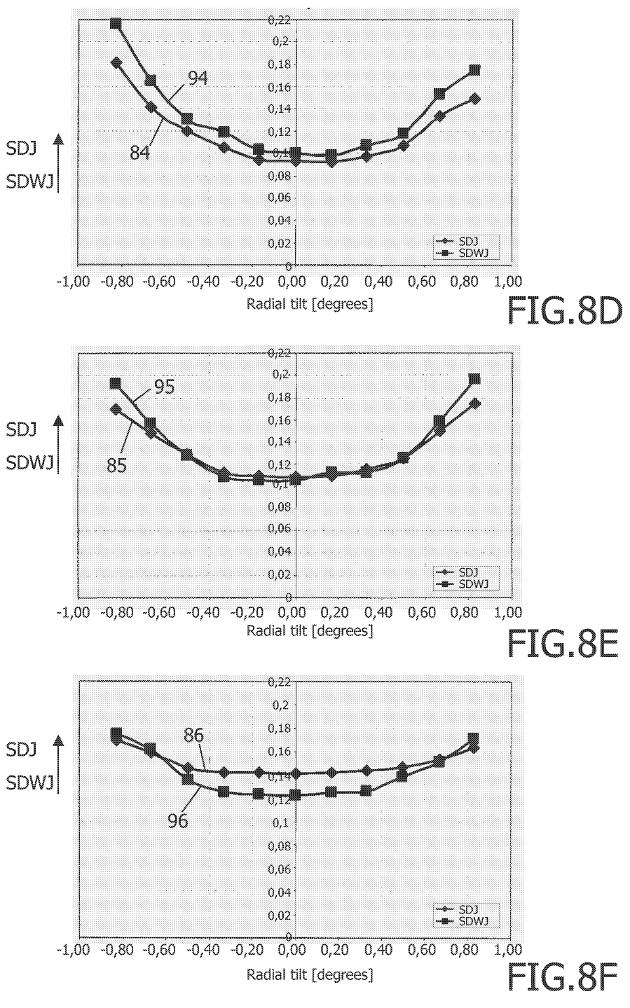

FIGS. 8A-8F are graphs illustrating experimental results;

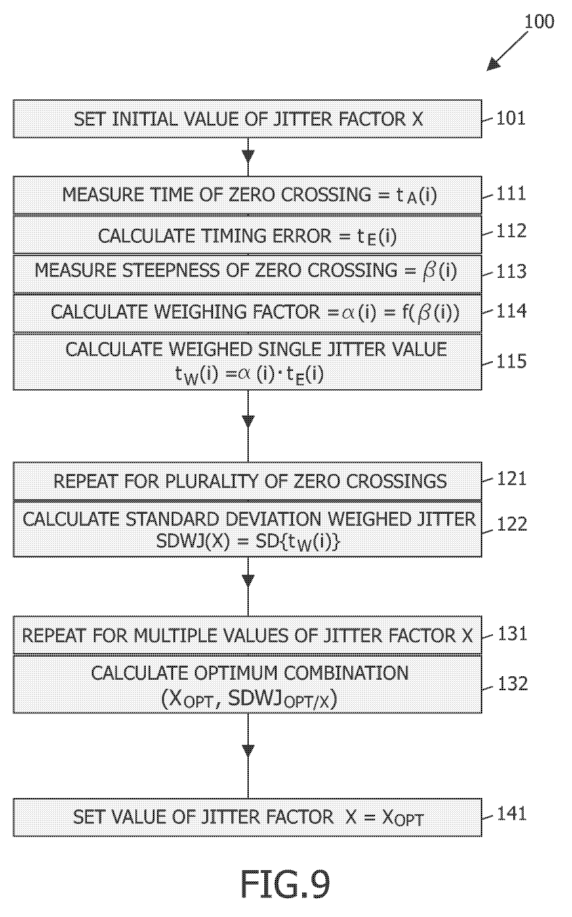

FIG. 9 is a flow diagram schematically illustrating a calibration procedure according to the present invention.

FIG. 2 schematically illustrates an optical disc drive apparatus 1, suitable for storing information on or reading information from an optical disc 2, typically a DVD or a CD or a BD. For rotating the disc 2, the disc drive apparatus 1 comprises a motor 4 fixed to a frame (not shown for sake of simplicity), defining a rotation axis 5.

The disc drive apparatus 1 further comprises an optical system 30 for scanning tracks (not shown) of the disc 2 using an optical beam. More specifically, in the exemplary arrangement illustrated in FIG. 2, the optical system 30 comprises a light beam generating means 31, typically a laser such as a laser diode, arranged to generate a light beam 32. In the following, different sections of the optical path of a light beam 32 will be indicated by a character a, b, c, etc added to the reference numeral 32, respectively.

The light beam 32 passes a beam splitter 33 and an objective lens 34 to reach (beam 32b) the disc 2. The first light beam 32b reflects from the disc 2 (reflected first light beam 32c) and passes the objective lens 34 and the beam splitter 33 (beam 32d) to reach an optical detector 35.

The objective lens 34 is designed to focus the light beam 32b in a focal spot F on a recording layer 2A of the disc 2, which spot F normally is circular. The disc drive apparatus 1 further comprises an actuator system 50, which comprises a radial actuator 51 for radially displacing the objective lens 34 with respect to the disc 2. Since radial actuators are known per se, while the present invention does not relate to the design and functioning of such radial actuator, it is not necessary here to discuss the design and functioning of a radial actuator in great detail.

For achieving and maintaining a correct focusing, exactly on the desired location of the disc 2, said objective lens 34 is mounted axially displaceable, while further the actuator system 50 also comprises a focal actuator 52 arranged for axially displacing the objective lens 34 with respect to the disc 2. Since axial actuators are known per se, while further the design and operation of such axial actuator is no subject of the present invention, it is not necessary here to discuss the design and operation of such focal actuator in great detail.

For the purpose of tilt compensation, said objective lens is mounted such as to be pivotable about a pivot axis (not shown) which preferably coincides with the optical centre of the objective lens 34. Further, the actuator system 50 also comprises a pivot actuator 53, also indicated as tilt actuator, arranged for pivoting the objective lens 34 with respect to the disc 2.

It is noted that means for supporting the objective lens with respect to an apparatus frame, and means for axially and radially displacing the objective lens, are generally known per se. Since the design and operation of such supporting and displacing means are no subject of the present invention, it is not necessary here to discuss their design and operation in great detail. The same applies to means for pivoting the objective lens.

It is further noted that the radial actuator 51, focal actuator 52, and pivot actuator 53 may be implemented as one integrated 3D-actuator.

The disc drive apparatus 1 further comprises a control circuit 90 having a first output 91 coupled to a control input of the radial actuator 51, having a second output 92 coupled to a control input of the focal actuator 52, having a third output 93 coupled to a control input of the pivot actuator 53, and having a fourth output 94 connected to a control input of the motor 4. The control circuit 90 is designed to generate at its first control output 91 a control signal S_{CR} for controlling the radial actuator 51, to generate at its second output 92 a control signal S_{CF} for controlling the focal actuator 52, to generate at its third output 93 a control signal S_{CT} for controlling the pivot actuator 53 and to generate at its fourth output 94 a control signal S_{CM} for controlling the motor 4.

The control circuit 90 further has a read signal input 95 for receiving a read signal S_{R} from the optical detector 35.

FIG. 3A schematically illustrates the shape of the read signal S_{R}. Basically, the read signal S_{R} shows two different signal levels, corresponding to different reflectivity of the optical disc 2 in the case of absence or presence of a pit, thus representing logical ones and zero. For instance, the higher signal level in FIG. 3A may represent a logical “1” while the lower signal level in FIG. 3A may represent a logical “0”.

The data bits are expected to have a fixed length, and to appear at a fixed data rate, so the transitions from one bit to the next are expected to occur at fixed time intervals. FIG. 3A also shows an illustrative data clock signal φ_{B} as a block signal, having a clock period T, the rising edges determining the expected bit transition moments. These moments are indicated as clock times t_{C}. In practice, such clock signal is generated by a PLL synchronised by the data signal.

The read signal S_{R} is processed as an AC signal, so at a transition from one bit value to a different bit value, the read signal S_{R} shows a zero-crossing, such as for instance indicated by arrow A in FIG. 3A. In the case of two successive bits having the same value, the read signal S_{R} maintains its value and no zero crossing occurs, such as for instance indicated by arrow B in FIG. 3A.

On a larger scale, FIG. 3B illustrates a timing error of a zero crossing. An expected bit transition moment is indicated at t_{C}, while the read signal S_{R} actually crosses the zero-level at time t_{A}. The absolute value |t_{C}−t_{A}| is taken as timing error t_{E}.

The phenomenon of such timing errors is generally indicated as “jitter”. For sake of clarity, the timing error of one zero crossing will hereinafter be indicated as “single jitter” J1=t_{E}.

The single jitter will vary from one zero-crossing to another. The variation of the single jitter is a measure for the quality of the data channel. In practice, a statistical value is calculated, which represents this variation, as follows. For a large number of zero crossings, the timing error t_{E}(i)=|t_{C}(i)−t_{A}(i)| is measured, the index i distinguishing the individual measurements. Thus, an ensemble is obtained of a large number of timing errors t_{E}(i); this ensemble is indicated as {t_{E}(i)}.

The ensemble {t_{E}(i)} is a collection of single jitter values having an average value AV{t_{E}(i)} and a standard deviation SD{t_{E}(i)}, calculated in accordance with well-known mathematical formulas. This standard deviation SD{t_{E}(i)} represents the variation of the single jitter J1(i), and will hereinafter be indicated as standard deviation jitter SDJ. In a formula:

SDJ=SD{t_{E}(i)} (1)

when expressed in time units, or

SDJ=SD{t_{E}(i)}*100%/T (2)

when expressed as a percentage of the clock period T.

There are several apparatus parameters (indicated as jitter factor), which have an influence on the timing errors t_{E} and hence on the standard deviation jitter SDJ. An example of such jitter factor is the radial tilt, mainly caused by an umbrella-shaped deformation of the disc. Using the tilt actuator 53, the tilt can be changed, and the standard deviation jitter SDJ can be calculated for different values of the radial tilt. As already mentioned earlier, the curve in FIG. 1 is a typical example of a resulting bathtub curve, more or less parabolic, having a minimum value for the standard deviation jitter SDJ, which minimum value corresponds to an optimum setting for the radial tilt.

Similar curves are obtained when different jitter factors are varied. In the following, a jitter factor will be indicated by the character X, the optimum setting value of the jitter factor X will be indicated as X_{OPT}, and the corresponding minimum value for the standard deviation jitter SDJ will be indicated as SDJ_{OPT/X}.

Jitter factors are also some of the parameters controlling the bit detection, like for example equalizer settings. Moreover, it is noted that one of the main applications of the jitter measurement is the calibration of the writing power, or more generally any parameter defining the writing pulses, during recording. The notion of jitter factor can be intended to comprise also a such parameter.

In practice, the standard deviation jitter SDJ is used to calibrate the setting of a jitter factor X. For a certain number of different values of the jitter factor X, the resulting timing errors are measured and the corresponding standard deviation jitter SDJ is calculated. From these measurements, the optimum setting value X_{OPT} is calculated, and the jitter factor X is set at this optimum setting value X_{OPT}.

FIG. 4 is a graph similar to FIG. 1, illustrating an effect at increased storage capacity and corresponding increased bit rate. The Fig. shows a first jitter curve 61, comparable to the curve of FIG. 1, corresponding to a relatively low capacity. The Fig. further shows a second jitter curve 62, corresponding to a relatively large capacity. The first jitter curve 61 would be typical for Blu-Ray discs having a capacity of 23 GB, while the second jitter curve 62 would be typical for Blu-Ray discs having a capacity of 27 GB. When comparing these two jitter curves, it can clearly be seen that the second jitter curve 62 is flatter, and its minimum value SDJ_{OPT/X} is higher, as compared to the first jitter curve 61. Thus, with a view to the calibration of jitter factors, the second jitter curve 62 has reduced resolution. This may reduce the playability of high-capacity optical discs.

Thus, there is a need to increase the resolution of a calibration method based on timing errors. Specifically, the present invention aims to provide a numerical parameter which should satisfy the following conditions:

a) like the standard deviation jitter SDJ, it must be possible to calculate such numerical parameter from an ensemble of measurements obtained from individual zero crossings;
b) such numerical parameter must be sensitive to changes in a jitter factor X;
c) the sensitivity of such numerical parameter for changes in the jitter factor X must be higher than the sensitivity of the standard deviation jitter SDJ (increased resolution);
d) such numerical parameter must have an optimum value at the optimum setting value X_{OPT} of the jitter factor X, i.e. coinciding with the optimum value SDJ_{OPT/X} of the standard deviation jitter SDJ.

While FIG. 3A shows an ideal shape of the read signal S_{R}, which can be realized in the case of optical discs having a relatively low storage capacity, FIG. 5A schematically illustrates what happens at increased storage capacity and corresponding increased bit rate: the signal looses its symmetry with respect to zero. It may happen that the signal, when changing from one value to the opposite value, barely crosses the zero level and then returns before reaching the said opposite value, as indicated by arrows A. It may also be that the signal, in a situation where it should maintain its value, shows a spurious dip approaching and perhaps reaching the zero level, as indicated by arrow B.

On a larger scale, FIG. 5B illustrates that, in a case where the read signal S_{R} does not “fully” reach the opposite value but only barely crosses the zero level, a relatively large timing error is introduced. The Fig. shows two clock times t_{C1} and t_{C2}, and a top of the read signal S_{R} crossing the zero level at two actual crossing times t_{A1} and t_{A2}. Even if the timing of the read signal S_{R} per se is perfect, in the sense that the top of the read signal S_{R} is situated halfway between the two clock times t_{C1} and t_{C2}, the timing error is large.

Based on this consideration, the present invention proposes to use a statistical jitter value in which the zero crossings associated with such “incomplete” zero-crossings have a reduced contribution.

As a measure for the “completeness” of a zero-crossing, the steepness of that zero-crossing is taken, which will be indicated by the character P. It can be seen from FIG. 5B that, in the case of an “incomplete” zero-crossing, the steepness (time-derivative) of the zero-crossing is smaller than in the case of a “complete” zero-crossing from the first level to the second level or vice versa. Thus, the present invention proposes to weigh the measured timing errors on the basis of the steepness of the corresponding zero-crossing.

FIG. 6 is a graph showing a zero-crossing of the read signal S_{R} illustrating that it is relatively easy to calculate a value representing the steepness. In general, for calculating the time t_{A} of a zero-crossing, the read signal S_{R} is sampled at regular sampling times. FIG. 6 illustrates that the sampling frequency may be higher than the bit frequency, but it is also possible to apply the principle of sub-sampling, as will be clear to a person skilled in the art. In FIG. 6, the sampling times are indicated as τ₁, τ₂, etc. On opposite sides of the zero level, successive samples Sx and Sy, taken at successive sampling times τ_{X} and τ_{Y}, respectively, have mutually opposite signs. It can be seen that the timing t_{A} of the zero-crossing can be estimated, in first order approximation, as:

$${t}_{A} = {τ}_{X} + \frac{{S}_{X}}{{S}_{X} + {S}_{Y}} \cdot ( {τ}_{Y} - {τ}_{X} ) \qquad ( 3 )$$

Further, it can be seen that the steepness 0 of this zero-crossing can be estimated, in first order approximation, as:

$$β = \frac{d S}{d t} = \frac{\vert {S}_{X} \vert + \vert {S}_{Y} \vert}{{τ}_{Y} - {τ}_{X}} \qquad ( 4 )$$

In the state of the art, the single jitter value J1 of this zero-crossing would be calculated as J1=t_{E}=|t_{C}−t_{A}|, as mentioned above. In contrast, the present invention proposes to use a weighed single jitter value t_{W} defined as

t_{W}=α·t_{E} (5)

α being a weighing factor which depends on the steepness β according to the formula

α=f(β) (6)

According to the invention, a should be proportional to P. In general, the function f may be expressed as a polynome as follows:

$$α = {\sum }_{i = 0}^{M} {c}_{i} \cdot {β}^{i} \qquad ( 7 a )$$

cᵢ being coefficients and M indicating a maximum number of terms.

Preferably, f is a linear function, so all coefficients are approximately zero except c₁.

As a further preference, the zero-crossings having the highest steepness are discarded, i.e.

α=0 for β>β_{L} (7b)

β_{L} being a limit value.

FIG. 7 is a graph illustrating this preferred function f.

The exact value of c₁ is not important, since this coefficient behaves as a scale factor. Therefore, for the sake of simplicity, this coefficient is chosen to be equal to 1/β_{L}, so that α a reaches a normalized maximum value α=1 for β=β_{L}, as illustrated in FIG. 7.

Experiments have shown that good results are achieved if β_{L} is chosen in a range between 0.75·β_{M} and 0.92·β_{M}, while the best results are achieved if β_{L} is chosen to be approximately equal to 0.83·β_{M}. Here, β_{M} represents the maximum value of 0 that can be observed, corresponding to the ideal full data signal transition.

Similar as in the state of the art, the weighed single jitter value t_{W}(i) is measured for a large number of zero crossings, giving an ensemble {t_{W}(i)}, and a standard deviation weighed jitter SDWJ is calculated according to the formula:

SDWJ=SD{t_{W}(i)}*100%/T (8)

When this standard deviation weighed jitter SDWJ is calculated for different values of the jitter factor X, a bathtub curve is obtained which is typically somewhat deeper than the bathtub curve of the traditional jitter value. This is illustrated by curve 63 in FIG. 4. A comparison with curve 62 shows the increased depth and hence the enhanced resolution. It is noted that the exact height of the curve 63 is not relevant: curve 63 is shown lower than curves 62 and 61 for sake of clarity, but curve 63 may be higher or lower, depending on the choice of parameter c₁.

FIGS. 8A-8F are graphs showing experimental results where the standard deviation jitter SDJ of the state of the art is compared with the standard deviation weighed jitter SDWJ according to the present invention. In all experiments, a measurement involved an ensemble of 25000 zero-crossings, and, for calculating SDWJ, β_{L} was chosen to be equal to 0.833·β_{M}. In all graphs, the vertical axis represents standard deviation jitter SDJ and standard deviation weighed jitter SDWJ, respectively. In FIGS. 8A-8C, the horizontal axis represents the focus offset in nm; in FIGS. 8D-8F, the horizontal axis represents the radial tilt in degrees. FIGS. 8A and 8D relate to a Blu-Ray disc having a capacity of 23 GB, FIGS. 8B and 8E relate to a Blu-Ray disc having a capacity of 25 GB, and FIGS. 8C and 8F relate to a Blu-Ray disc having a capacity of 27 GB. Diamonds indicate measured standard deviation jitter SDJ, squares indicate measured standard deviation weighed jitter SDWJ.

When comparing the curves 81, 82, 83 in FIGS. 8A, 8B, 8C, it can be seen that the jitter curve is flatter for higher capacity discs. The same applies when comparing the curves 84, 85, 86 in FIGS. 8D, 8E, 8F. Further, it can be seen that the jitter level increases for higher capacity discs.

When comparing the curves 91, 92, 93, 94, 95, 96 with the curves 81, 82, 83, 84, 85, 86, respectively, it can be seen that the curves of the standard deviation weighed jitter SDWJ are always deeper than the corresponding curves of the standard deviation jitter SDJ, while the minimum always has substantially the same horizontal position.

This illustrates that the standard deviation weighed jitter SDWJ is better suitable for calibration purposes than the standard deviation jitter SDJ.

Although the improvements offered by the invention are most noticeable for higher capacity discs, there is also a slight improvement noticeable for lower capacity discs. Further, it is believed that the present invention also offers an improvement in the case of discs which have reduced playability for other reasons (so-called horror discs).

FIG. 9 is a flow diagram schematically illustrating a calibration procedure 100 according to the present invention.

First, a jitter factor X (for instance: tilt) is set to an initial value [step 101].

With this setting of the jitter factor X, a read signal S_{R} is processed by the control circuit 90. For a certain zero-crossing of the read signal S_{R}, the timing t_{A}(i) is measured [step 111], the timing error t_{E}(i) is calculated [step 112]. Further, the steepness β(i) is measured [step 113] and the weighing factor α(i) is calculated [step 114]. From these data, the weighed single jitter value t_{W}(i) is calculated [step 115].

The above steps are repeated for a plurality of zero-crossing [step 121] to obtain an ensemble of weighed single jitter values {t_{W}(i)}. From this ensemble, the standard deviation is calculated to obtain the standard deviation weighed jitter SDWJ(X) [step 122] for this value of the jitter factor X.

The above is repeated for multiple different values of the jitter factor X [step 131], to obtain a relevant part of a bathtub curve. For this curve, an optimum combination (X_{OPT}, SDWJ_{OPT/X}) is calculated [step 132].

Finally, the value of the jitter factor X is set to the calculated optimum value X_{OPT} [step 141].

The above may be repeated for different jitter factors, as will be clear.

It should be clear to a person skilled in the art that the present invention is not limited to the exemplary embodiments discussed above, but that several variations and modifications are possible within the protective scope of the invention as defined in the appending claims. For instance, other methods may be used for calculating an estimate for the reference level crossing and/or for the steepness of such crossing.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

It is noted that the present invention can be embodied in a method, and in an optical disc drive designed to perform the method. However, the present invention can be embodied in any device, including an IC, designed for calculating a jitter value on the basis of a data signal. For calculating timing errors, such device may receive an external clock signal or may be designed to generate an internal clock signal itself.

1. Method for calculating a jitter value for a digital signal, the method comprising the steps of:
receiving the digital signal (S_{R});
detecting a reference-crossing in the digital signal (hereinafter indicated as zero-crossing);
measuring (steps 111, 112) a timing error (t_{E}(i)) of the zero-crossing;
measuring (step 113) a steepness (β(i)) of the zero-crossing;
calculating (step 114) a weighing factor (α(i)) on the basis of the measured steepness (β(i)), this weighing factor (α(i)) being smaller for smaller values of the steepness (β(i));
calculating (step 115) a weighed single jitter value (t_{W}(i)) by multiplying said timing error (t_{E}(i)) and said weighing factor (α(i)).

2. Method for calculating a jitter value (SDWJ) for a digital signal, the method comprising the steps of:
detecting a plurality of zero-crossings in the digital signal;
for each zero-crossing, calculating the weighed single jitter value (t_{W}(i)) using the method of claim 1, to obtain an ensemble {t_{W}(i)} of weighed single jitter values for said plurality of zero-crossings;
and calculating (step 122) the jitter value (SDWJ) as a statistical relevant representative jitter value (SDWJ) for said ensemble {t_{W}(i)}.

3. Method according to claim 2, wherein said statistical relevant representative jitter value is a standard deviation weighed jitter value (SDWJ) calculated as the standard deviation of the weighed single jitter values (t_{W}(i)) of said ensemble {t_{W}(i)}, according to the formula SDWJ=SD {t_{W}(i)}.

4. Method according to claim 1, wherein the steepness (β(i)) of a zero-crossing is substantially equal to the time-derivative of the digital signal (S_{R}) in the zero-crossing.

5. Method according to claim 1, wherein the digital signal (S_{R}) is sampled;
wherein at least a first sample (Sx) is obtained at a first sampling time (τ_{X}), and a second sample (Sy) is obtained at a second sampling time (τ_{Y}), the first and second samples being at opposite sides of the reference level being crossed;
and wherein the steepness (β(i)) of this zero-crossing is calculated in accordance with the following formula:
$$β = \frac{d S}{d t} = \frac{\vert {S}_{X} \vert + \vert {S}_{Y} \vert}{{τ}_{Y} - {τ}_{X}}$$

6. Method according to claim 5, wherein the timing (t_{A}) of the zero-crossing is calculated in accordance with the following formula:
$${t}_{A} = {τ}_{X} + \frac{{S}_{X}}{{S}_{X} + {S}_{Y}} \cdot ( {τ}_{Y} - {τ}_{X} )$$

7. Method according to claim 1, wherein the weighing factor (α(i)) is calculated in accordance with the following formula:
$$α = {\sum }_{i = 0}^{M} {c}_{i} \cdot {β}^{i}$$
cᵢ being coefficients and M indicating a maximum number of terms.

8. Method according to claim 7, wherein all coefficients c₀ and cᵢ for i≧2 are approximately zero.

9. Method according to claim 1, wherein the weighing factor (α(i)) is equal to zero for β>β_{L}, β_{L} being a limit value.

10. Method according to claim 9, wherein β_{L} is chosen in a range between 0.75·β_{M} and 0.92·β_{M}, β_{M} representing the maximum value of β that can be observed.

11. Method according to claim 10, wherein β_{L} is approximately equal to 0.83·β_{M}.

12. Method for calibrating a jitter factor (X) in an optical disc drive apparatus (1) on the basis of optimising jitter, the method comprising the steps of:
calculating a weighed single jitter value (t_{W}(i)) for a read signal (S_{R}) from an optical disc (2) using the method of claim 1;
and using this weighed single jitter value for calibration.

13. Method for calibrating a jitter factor (X) in an optical disc drive apparatus (1) on the basis of optimising jitter, the method comprising the steps of:
calculating a statistical relevant representative jitter value (SDWJ) for a read signal (S_{R}) from an optical disc (2) using the method of claim 2;
and using this statistical relevant representative jitter value for calibration.

14. Method according to claim 12, wherein said jitter factor (X) is set (step 141) to an optimum value (X_{OPT}) where said statistical relevant representative jitter value (SDWJ) has a minimum value (SDWJ_{OPT/X}).

15. Method according to claim 14, wherein said statistical relevant representative jitter value (SDWJ) is calculated (step 131) for multiple values of said jitter factor (X), and wherein said minimum value (SDWJ_{OPT/X}) is taken as the lowest value of the measured results.

16. Method according to claim 14, wherein said statistical relevant representative jitter value (SDWJ) is calculated (step 131) for multiple values of said jitter factor (X), and wherein said minimum value (SDWJ_{OPT/X}) is calculated by interpolation of the measured results.

17. Method according to claim 12, wherein the jitter factor is one or more of tilt, focus offset, spherical aberration, detracking, or other drive parameters that influence the jitter or jitter-based indication.

18. Optical disc drive apparatus (1), suitable for storing information on or reading information from an optical disc (2), typically a DVD or a CD or a BD, the disc drive apparatus being designed for performing the calibration method of claim 12.

19. Device for calculating a jitter value (SDWJ) for a digital signal, the device (90) having an input (95) for receiving the digital signal (S_{R});
the device being designed for performing the calculating method of claim 1.

20. Integrated Circuit comprising a device according to claim 19.
